(19) United States
(12) Patent Application Publication
(10) Pub. No.: US 2013/0067418 A1
(43) Pub. Date: Mar. 14, 2013

(54) IMAGE PROCESSING APPARATUS, METHOD AND PROGRAM

(71) Applicant: Kentaro Fukazawa, Tokyo (JP)

(72) Inventor: Kentaro Fukazawa, Tokyo (JP)

(73) Assignee: SONY CORPORATION, Tokyo (JP)

(21) Appl. No.: 13/599,040

(22) Filed: Aug. 30, 2012

(30) Foreign Application Priority Data
Sep. 9, 2011 (JP) 2011-197033

(51) Int. Cl. G06F 3/048

(52) U.S. Cl. 715/856

(57) ABSTRACT

Provided is an image processing apparatus including an edge strength calculation section which respectively calculates edge strengths for all pixels of an image represented by image data set as an object to be processed, a cursor position acquisition section which successively acquires positions of a cursor on a display screen on which the image is displayed, and a cursor speed setting section which sets a moving speed of the cursor based on a variation of the edge strength in a current position of the cursor, calculated based on the positions of the cursor successively acquired by the cursor position acquisition section and the edge strengths calculated by the edge strength calculation section.

### CROSS-REFERENCE TO RELATED APPLICATION

The present application claims priority from Japanese Patent Application No. JP 2011-197033 filed in the Japanese Patent Office on Sep. 9, 2011, the entire content of which is incorporated herein by reference.

### BACKGROUND

The present disclosure relates to an image processing apparatus, method and program, and more specifically to an image processing apparatus, method and program that can simplify forming work of a border line of a region to be processed.

In the past, techniques such as the following first and second techniques have been known as techniques for simplifying forming work of a border line of a region to be processed in an image process.

The first technique is a technique which extracts, when an outline of a prescribed object is roughly specified by a mouse operation of a user, an outline of the specified object as a border line to be processed (refer to JP 10-191020A).

The second technique is a technique which extracts, in the case where a deviation occurs between the position of an outline of a prescribed object specified by an operation of a user and the position of an outline of the prescribed object, and if this deviation is within an allowable range, a line along the outline of the prescribed object as a border line to be processed.

### SUMMARY

However, in the first technique, the extracted border line may not necessarily be a border line desired by the user and the user may often have to correct the extracted border line, and there is the possibility that forming work of the border line may become complicated.

In the second technique, the extracted border line may not necessarily display the correct border line of the prescribed object. Further, in the case where the above deviation is outside the allowable range, a border line along the outline of the prescribed object is not extracted, and a line shifted from the outline of a prescribed object specified by the user is extracted as a border line indicating the object to be processed. In addition, even if the position specified by the user is a position of an outline desired by the user, there are cases where a border line along the outline of an incorrect position is extracted as a border line indicating the object to be processed. In any case, the user may have to correct the extracted border line, and there is the possibility that forming work of the border line may become complicated.

The present disclosure has been made in view of such situations, and can simplify forming work of the border line of a region to be processed.

According to an embodiment of the present disclosure, there is provided an image processing apparatus, including an edge strength calculation section which respectively calculates edge strengths for all pixels of an image represented by image data set as an object to be processed, a cursor position acquisition section which successively acquires positions of a cursor on a display screen on which the image is displayed, and a cursor speed setting section which sets a moving speed of the cursor based on a variation of the edge strength in a current position of the cursor, calculated based on the positions of the cursor successively acquired by the cursor position acquisition section and the edge strengths calculated by the edge strength calculation section.

The cursor speed setting section may set the moving speed of the cursor so that, in a case where the variation of the edge strength is positive, the more an absolute value of the edge strength increases, the more the moving speed of the cursor may be set to a higher speed, and in a case where the variation of the edge strength is negative, the more an absolute value of the edge strength increases, the more the moving speed of the cursor may be set to a lower speed.

The cursor speed setting section may calculate forward positions of the cursor in a direction of movement of the current position of the cursor, and may calculate the variation of the edge strength in the current position of the cursor, by using the edge strength in each of the calculated forward positions of the cursor, and backward positions of the cursor in the direction of movement already obtained by the cursor position acquisition section.

The cursor speed setting section may calculate, as the forward positions of the cursor, positions at point symmetry of the backward positions of the cursor centered on the current position of the cursor.

The cursor speed setting section may obtain an approximate curved line represented by a multiple-order polynomial equation, from the backward positions of the cursor, and may calculate the forward positions of the cursor by using the approximate curved line.

The cursor speed setting section may calculate the variation of the edge strength in the current position of the cursor, by using a maximum value and a minimum value of the edge strengths in the backward positions of the cursor, and a maximum value and a minimum value of the edge strengths in the forward positions of the cursor.

An image processing method and program according to the embodiment of the present disclosure are the method and program corresponding to the image processing apparatus according to the embodiment of the present disclosure described above.

According to the embodiments of the present disclosure, there is provided an image processing apparatus, method and program, in which the edge strengths are respectively calculated for all the pixels of an image represented by image data set as an object to be processed, the positions of a cursor on a display screen, on which the image is displayed, are successively acquired, and a moving speed of the cursor is set based on a variation of an edge strength in a current position of the cursor, which is based on the successively acquired positions of the cursor and the calculated edge strengths.

According to the present disclosure as stated above, forming work of a border line of a region to be processed can be simplified.

### BRIEF DESCRIPTION OF THE DRAWINGS

FIG. 1 is a figure describing the outline of the present disclosure;

FIG. 2 is a block diagram showing a configuration example of an image processing apparatus applicable to the present disclosure;

FIG. 3 is a block diagram showing a configuration example of a cursor speed setting section;

FIG. 4 is a figure showing a prediction technique of forward coordinates in a direction of movement;

FIG. 5 is a figure showing another example of a prediction technique of forward coordinates in a direction of movement;

FIG. 6 is a figure showing an example of variables used to calculate a variation AL of the edge strength;

FIG. 7 is a figure showing a relation between the moving speed of the cursor and the variation AL of the edge strength;

FIG. 8 is a flow chart describing the flow of a cursor speed setting process;

FIG. 9 is a figure showing a configuration example of another image processing apparatus;

FIG. 10 is a figure describing the use of trajectory information in the another image processing apparatus;

FIG. 11 is a figure showing a configuration example of the another image processing apparatus;

FIG. 12 is a figure describing the use of trajectory information in the another image processing apparatus; and

FIG. 13 is a block diagram showing a configuration example of hardware of an image processing apparatus applicable to the present disclosure.

### DETAILED DESCRIPTION OF THE EMBODIMENT(S)

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

Firstly, in order to easily understand the present disclosure, an outline of the present disclosure will be described.

In the present disclosure, in the case where a user performs forming work of a border line of a region to be processed using a pointing device such as a mouse, the moving speed of a cursor of the mouse is dynamically set depending on an image feature amount of the position of the cursor. In this way, the user can easily perform forming work of a border line along an outline of an object. Note that in the present disclosure, a variation of edge strength is applied as the image feature amount, and the moving speed of the cursor is dynamically set depending on the variation of the edge strength of the position of the cursor.

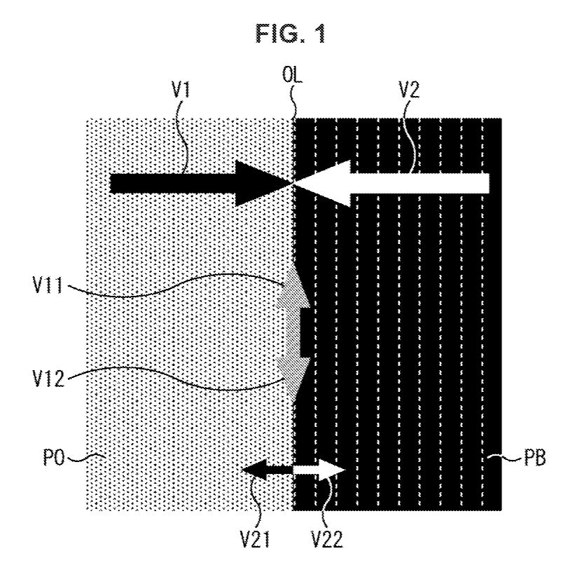

FIG. 1 is a figure for describing the outline of the present disclosure, and is a figure showing one part of an image. The part of the image shown in FIG. 1 shows a situation where part of an object PO is superimposed onto a background image PB. Therefore, a border line of the object PO and the background image PB (that is, an edge) becomes an outline OL of the object PO.

The arrows shown in FIG. 1 show the movement of the cursor. That is, the direction of the arrows shows a moving direction of the cursor, and the thickness of the arrows shows a moving speed of the cursor. Such arrows are hereinafter called movements of the cursor.

As shown in FIG. 1, the moving direction of the cursor, according to the movements V1, V2 of the cursor, is in a direction towards the outline OL of the object PO. Specifically, the moving direction of the cursor, according to the movement V1 of the cursor, is in a direction from the object PO towards the background image PB, and in a direction towards the outline OL of the object PO. On the other hand, the moving direction of the cursor, according to the movement V2 of the cursor, is in a direction from the background image PB towards the object PO, and in a direction towards the outline OL of the object PO.

In this way, in the case where the cursor moves towards the outline OL of the object PO, the edge strength at the position of the cursor increases. In a word, a variation of the edge strength at the position of the cursor increases. In such a case, as the movements V1, V2 of the cursor are shown thicker, the moving speeds are set at a higher speed. That is, the cursor movement on a display screen is set so as to be increased with respect to the actual movement of the pointing device.

The moving direction of the cursor, according to the movements V11, V12 of the cursor, is in a direction along the outline OL of the object PO. Specifically, the moving direction of the cursor, according to the movement V11, of the cursor, is in a direction upwards within the figure, and in a direction along the outline OL of the object PO. On the other hand, the moving direction of the cursor, according to the movement V12 of the cursor, is in a direction downwards within the figure, and in a direction along the outline OL of the object PO.

In this way, in the case where the cursor moves along the outline OL of the object PO, the edge strength at the position of the cursor becomes constant. In a word, a variation of the edge strength at the position of the cursor becomes constant. In such a case, as the movements V11, V12 of the cursor are shown at a medium thickness, the moving speed of the cursor is set at a medium speed.

The moving direction of the cursor, according to the movements V21, V22 of the cursor, is in a direction away from the outline OL of the object PO. Specifically the moving direction of the cursor, according to the movement V21 of the cursor, is in a direction from the background image PB towards the object PO, and in a direction away from the outline OL of the object PO. On the other hand, the moving direction of the cursor, according to the movement V22 of the cursor, is in a direction from the object PO towards the background image PB, and in a direction away from the outline OL of the object PO.

In this way, in the case where the cursor moves towards a direction away from the outline OL of the object PO, the edge strength at the position of the cursor decreases. In a word, a variation of the edge strength at the position of the cursor decreases. In such a case, as the movements V21, V22 of the cursor are shown thinner, the moving speeds are set at a lower speed. That is, the cursor movement on a display screen is set so as to be decreased with respect to the actual movement of the pointing device.

As shown above, since the moving speed of the cursor is dynamically set depending on a variation of the edge strength of the position of the cursor, it becomes easy for a user to perform a moving operation of the cursor along the outline OL of the object PO, and the user can easily perform forming work of the border line along the outline OL of the object PO.

### [Configuration Example of an Image Processing Apparatus]

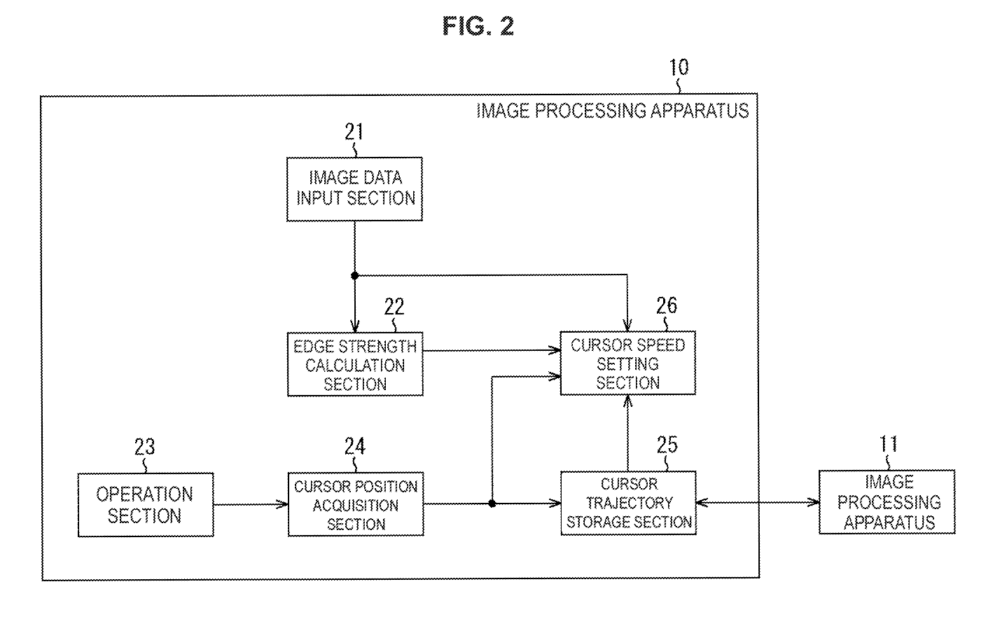

FIG. 2 is a block diagram showing a configuration example of an image processing apparatus applicable to the present disclosure.

As shown in FIG. 2, an image processing apparatus has an image data input section 21, an edge strength calculation section 22, an operation section 23, a cursor position acquisition section 24, a cursor trajectory storage section 25, and a cursor speed setting section 26.

The image data input section 21 inputs image data to be edited from another information processing apparatus or a storage section, not shown, and supplies the image data to the edge strength calculation section 22 and the cursor speed setting section 26.

The edge strength calculation section 22 respectively calculates the edge strengths for all the pixels of the image data, which is supplied from the image data input section 21 and set as an object to be processed. Note that the calculation technique of the edge strength is not particularly limited. For example, a technique can be adopted which respectively calculates the edge strengths for all the pixels, by setting each pixel configuring the image data as a pixel targeted to be processed (hereinafter, called a target pixel), calculating by substituting first order differentials Δx, Δy for each direction x, y of the target pixels and their adjacent pixels into the following Equation (1), and repeating these processes by successively updating the target pixel.

L=\sqrt{Δx²+Δy²} (1)

Note that the calculation technique of the first order differentials Δx, Δy is not particularly limited, and an arbitrary technique can be adopted, such as a technique which uses differences between adjacent pixels, or a technique using first order differential operators, such as Sobel or Roberts. Further, when calculating the edge strength L by the first order differentials Δx, Δy, noise may also be removed beforehand by applying a smoothing filter to the image data.

The edge strength calculation section 22 supplies the calculated edge strength L to the cursor speed setting section 26.

The operation section 23 receives an operation of a pointing device, such as a mouse, from the user, and supplies an operation signal corresponding to this operation to the cursor position acquisition section 24.

The cursor position acquisition section 24 successively acquires the coordinates (xn, yn) on a display screen, on which this cursor is displayed, as a current position N of the cursor, based on the operation signal supplied from the operation section 23. The cursor position acquisition section 24 supplies the coordinates (xn, yn) of the current position N of the cursor to the cursor trajectory storage section 25 and the cursor speed setting section 26.

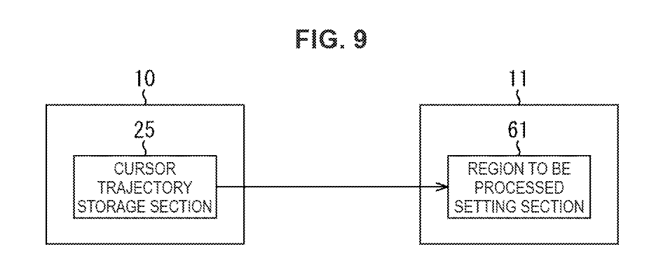

The cursor trajectory storage section 25 stores by adding the coordinates (xn, yn) of the current position N of the cursor supplied from the cursor position acquisition section 24 to a trajectory list as trajectory information. That is, the trajectory list is a list in which the coordinates (xn, yn) of a plurality of positions N of the cursor successively acquired by the cursor position acquisition section 24 are stored, in the order of acquisition, as trajectory information. The trajectory information stored in the cursor trajectory storage section 25 is supplied to the cursor speed setting section 26. Further, the trajectory information stored in the cursor trajectory storage section 25 is supplied to and used by another image processing apparatus 11. Note that the use of the trajectory information in the another image processing apparatus 11 will be described later by referring to FIGS. 9 to 12.

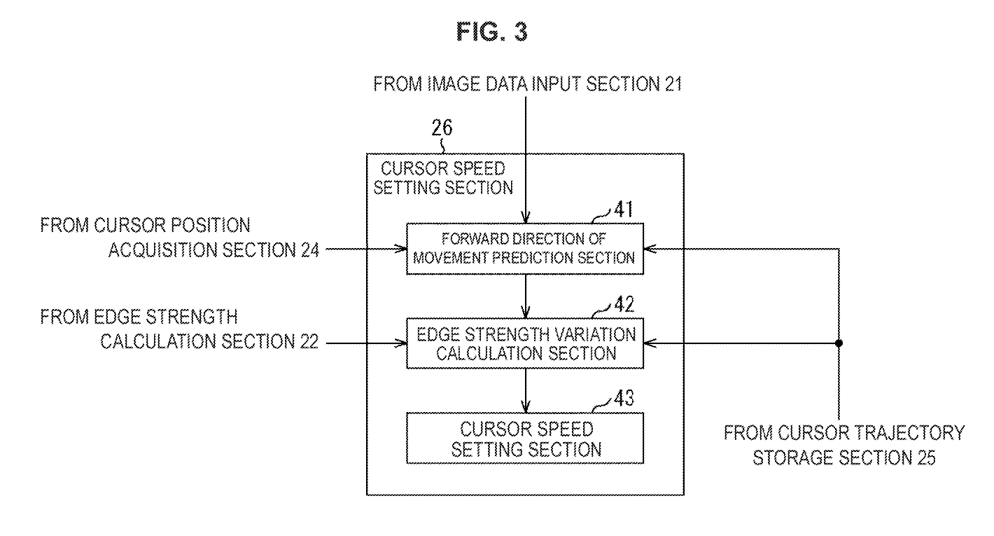

The cursor speed setting section 26 sets a moving speed of the cursor, depending on a variation ΔL of the edge strength L in the current position N of the cursor. The variation ΔL of the edge strength L is calculated by calculating forward and backward coordinates in a direction of movement centered on the coordinates of the current position N of the cursor, and using the edge strengths of the calculated coordinates. In this case, a backward (that is, a previous) edge strength in a direction of movement centered on the current position N of the cursor is calculated by using the trajectory information supplied from the cursor trajectory storage section 25. On the other hand, a forward edge strength in a direction of movement centered on the current position N of the cursor is calculated by predicting from the trajectory information of the backward cursor in a direction of movement. A detailed configuration of such a cursor speed setting section 26 which sets a moving speed of the cursor will be described by referring to FIG. 3.

### [Configuration Example of the Cursor Speed Setting Section]

FIG. 3 is a block diagram showing a configuration example of the cursor speed setting section 26.

The cursor speed setting section 26, such as that shown in FIG. 3, has a forward direction of movement prediction section 41, an edge strength variation calculation section 42 and a cursor speed setting section 43.

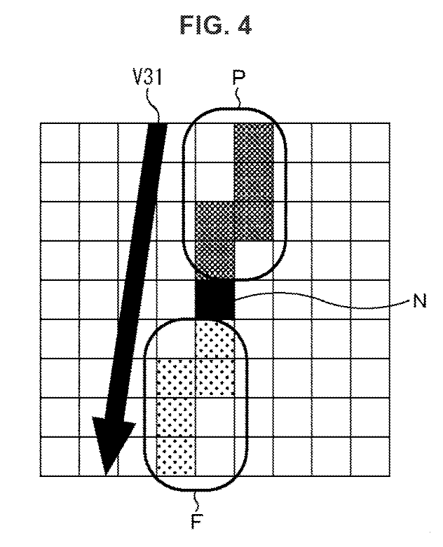

The forward direction of movement prediction section 41 calculates by predicting the forward coordinates in a direction of movement centered on the current position N of the cursor supplied from the cursor position acquisition section 24. The prediction technique of the forward coordinates in a direction of movement of the cursor is not particularly limited. For example, as shown in FIG. 4, a technique which predicts a coordinate group showing a forward trajectory in a direction of movement can be adopted by arranging a curved line (that is, a set of the points for each coordinate), similar to a backward (hereinafter, called a previous) trajectory in a direction of movement of the cursor, at point symmetry centered on the current position N of the cursor.

### [Prediction Technique of Forward Coordinates in a Direction of Movement]

FIG. 4 is a figure showing a prediction method of forward coordinates in a direction of movement.

As shown in FIG. 4, the forward direction of movement prediction section 41 sets the coordinates of the current position N of the cursor as an initial setting at the relative coordinates (0, 0), and sets the moving direction of the cursor to the direction shown by the movement V31 of the cursor. In this case, the forward direction of movement prediction section 41 acquires a coordinate group of the previous trajectory P of the cursor (that is, a trajectory information group) from the trajectory list stored in the cursor trajectory storage section 25. Then, the forward direction of movement prediction section 41 assumes that each point (that is, pixel) of the coordinate group of the previous trajectory P of the cursor and each corresponding point (that is, pixel) of the coordinate group arranged at point symmetry centered on the relative coordinates (0, 0) of the current position N of the cursor is a forward trajectory F in the direction of movement of the cursor.

Specifically, a corresponding point for the point of the relative coordinates (1, 4) within the previous trajectory P of the cursor is arranged in the relative coordinates (−1, −4) of the predicted cursor. Further, a corresponding point for the point of the relative coordinates (1, 3) in the previous trajectory P of the cursor is arranged in the relative coordinates (−1, −3) of the predicted cursor. By such an arrangement, the forward trajectory F in the direction of movement of the cursor is expressed by a set (that is, a coordinate group) of the corresponding points for each point configuring the previous trajectories P of the cursor. That is, the forward direction of movement prediction section 41 can calculate by predicting a coordinate group showing the forward trajectory F in a direction of movement, by arranging a curved line similar to the previous trajectory of the cursor at point symmetry centered on the current position of the cursor.

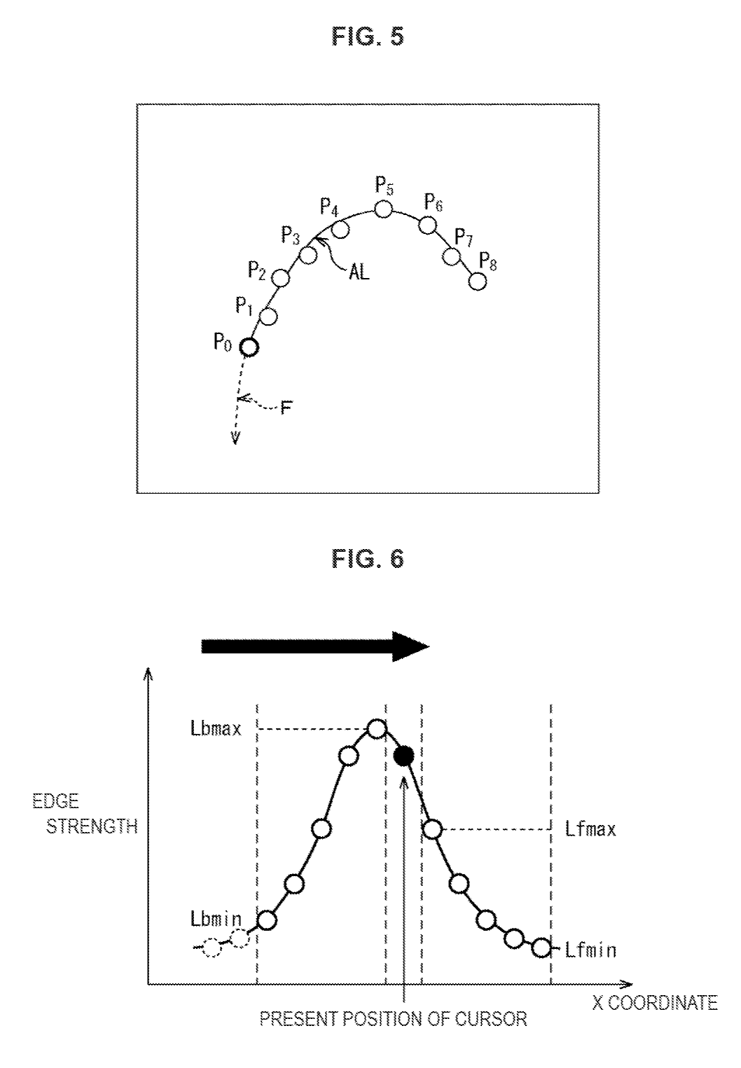

Further, for example, an approximate curved line can be obtained from each point of the previous trajectory of the cursor, and a technique which predicts by using this approximate curved line can be adopted as a prediction technique of a coordinate group showing a forward trajectory in the direction of movement. This technique will be described by referring to FIG. 5.

### [Another Example of a Prediction Technique of Forward Coordinates in a Direction of Movement]

FIG. 5 is a figure showing another example of a prediction technique of forward coordinates in a direction of movement.

In this prediction technique, an approximate curved line expressed by an n-order polynomial equation of the following Equation (2) is obtained as an approximate curved line AL of the previous trajectory P including the coordinate groups P0(x0, y0), P1(x1, y1) . . . Pm(xm, ym) of the previous trajectory P of the cursor.

Coefficients ak (where k is an integral value within the range of 1 to n) in Equation (2) are respectively calculated so that the sum of squares of the residuals of the theoretical values Pi′(xi, f(xi)) for the actual positions Pi(xi, yi) of the cursor are minimized, as shown in the following Equation (3).

$${E}^{2} = {\sum }_{i = 0}^{m} {( yi - f ( xi ) )}^{2} \qquad ( 3 )$$

Note that the range of the coordinate group of the previous trajectory P of the cursor used to approximate the nth order of the n-order polynomial shown by Equation (2) is assumed to be an arbitrary range.

Next, the forward direction of movement prediction section 41 calculates the forward trajectory F in the direction of movement of the cursor by extrapolation prediction for the approximate curved line AL represented by Equation (2). Then, the forward direction of movement prediction section 41 supplies the forward trajectory F in the direction of movement of the cursor to the edge strength variation calculation section 42.

### [Calculation of Edge Strength]

The edge strength variation calculation section 42 calculates the variation ΔL of the edge strength.

The edge strength variation calculation section 42 calculates a maximum value Lbmax and a minimum value Lbmin of the edge strength L in the previous trajectory P of the cursor, by using the edge strength L for all the pixels supplied from the edge strength calculation section 22, and the previous trajectory P of the cursor obtained from the trajectory information supplied from the cursor trajectory storing section 25. Note that the range which calculates the maximum value Lbmax and the minimum value Lbmin of the edge strength L is assumed to be an arbitrary range if it is within the range of the previous trajectory P of the cursor.

Further, the edge strength variation calculation section 42 calculates a maximum value Lfmax and a minimum value Lfmin of the edge strength L in the forward trajectory F in the direction of movement of the cursor, by using the edge strength L for all the pixels supplied from the edge strength calculation section 22, and the previous trajectory F in the direction of movement of the cursor supplied from the forward direction of movement prediction section 41. Note that the range which calculates the maximum value Lfmax and the minimum value Lfmin of the edge strength L is an arbitrary range if it is within the range of the forward trajectory F in the direction of movement of the cursor.

Then, the edge strength variation calculation section 42 calculates the variation ΔL of the edge strength by substituting the maximum values Lbmax, Lfmax and the minimum values Lbmin, Lfmin, into the following Equation (4).

$$Δ L = \{ \begin{matrix}Lf min - Lb max ( Lf max < Lb max ) \\ Lf max - Lb min ( Lf max > Lb max ) \\ 0 ( Lf max = Lb max )\end{matrix} \qquad ( 4 )$$

The operations of Equation (4) will be specifically described by using the example of FIG. 6.

FIG. 6 is a figure showing an example of variables used to calculate the variation ΔL of the edge strength. The vertical axis of FIG. 6 shows the edge strength and the horizontal axis shows the x coordinate. The moving direction of the cursor, as shown by the arrow, is towards the right hand side.

The white circles of FIG. 6 show the trajectory of the cursor, and the black circle shows the current position of the cursor. That is, the trajectory from the left hand side of the black circle represents the previous trajectory P of the cursor, and the trajectory from the right hand side of the black circle represents the forward trajectory F in a direction of movement of the cursor.

In the example of FIG. 6, the maximum value Lfmax of the edge strength L within the forward trajectory F in the direction of movement of the cursor is smaller than the maximum value Lbmax of the edge strength L of the previous trajectory P of the cursor. Therefore, corresponding to the case where (Lfmax<Lbmax) within the parentheses of the top line of Equation (4), the variation ΔL of the edge strength is calculated by (Lfmin−Lbmax) and the value becomes negative. In the case where the variation ΔL of the edge strength is negative, the moving direction of the cursor becomes a direction away from the edge, that is, a direction away from the outline OL of an object. Therefore, in the case where such a variation ΔL of the edge strength is negative, the moving speed of the cursor is set at a lower speed, by the cursor speed setting section 43, described later.

Further, while not shown in the figure, in the case where the maximum value Lfmax of the edge strength L within the forward trajectory F in the direction of movement of the cursor is larger than the maximum value Lbmax of the edge strength L of the previous trajectory P of the cursor, corresponding to the case where (Lfmax>Lbmax) within the parentheses of middle line of Equation (4), the variation ΔL of the edge strength is calculated by (Lfmax−Lbmin) and the value becomes positive. In the case where the variation ΔL of the edge strength is positive, the moving direction of the cursor becomes a direction towards the edge, that is, a direction towards the outline OL of an object. Therefore, in the case where such a variation ΔL of the edge strength is positive, the moving speed of the cursor is set at a higher speed, by the cursor speed setting section 43, described later.

Further, while not shown in the figure, in the case where the maximum value Lfmax of the edge strength L within the forward trajectory F in the direction of movement of the cursor is equal to the maximum value Lbmax of the edge strength L of the previous trajectory P of the cursor, corresponding to the case where (Lfmax=Lbmax) within the parentheses of the bottom line of Equation (4), the variation ΔL of the edge strength becomes 0. In the case where the variation ΔL of the edge strength is 0, the moving direction of the cursor becomes a direction along the edge, that is, a direction along the outline OL of an object. Therefore, in the case where such a variation ΔL of the edge strength is 0, the moving speed of the cursor is set at a medium speed, by the cursor speed setting section 43, described later.

The edge strength variation calculation section 42 supplies the calculated variation ΔL of the edge strength to the cursor speed setting section 43.

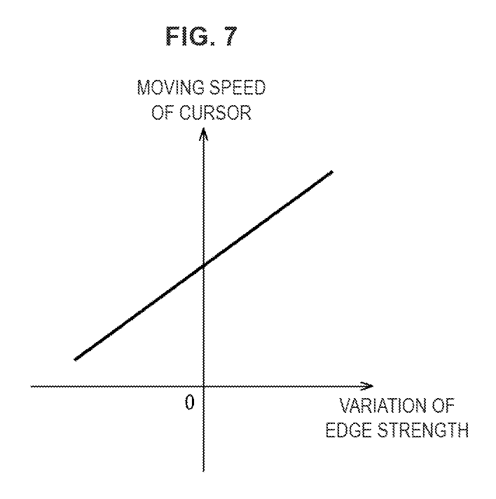

The cursor speed setting section 43 determines the moving speed of the cursor, based on the variation ΔL of the edge strength supplied from the edge strength variation calculation section 42. The relation between the moving speed of the cursor and the variation ΔL of the edge strength will be described by referring to FIG. 7.

### [Relation Between the Moving Speed of the Cursor and the Variation ΔL of the Edge Strength]

FIG. 7 is a figure showing the relation between the moving speed of the cursor and the variation ΔL of the edge strength. The vertical axis of FIG. 7 shows the moving speed of the cursor and the horizontal axis shows the variation ΔL of the edge strength.

As shown in FIG. 7, the moving speed of the cursor increases in proportion to the variation of the edge strength increasing in a positive direction. That is, in the case where the moving direction of the cursor is a direction towards the outline OL of an object, that is, in the case where the variation ΔL of the edge strength is positive, the more the variation ΔL of the edge strength increases, that is, the more the current position N of the cursor approaches the outline OL of an object, the more the cursor speed setting section 43 sets the moving speed of the cursor to a higher speed.

On the other hand, the moving speed of the cursor decreases in proportion to the variation of the edge strength increasing in a negative direction. That is, in the case where the moving direction of the cursor is a direction away from the outline OL of an object, that is, in the case where the variation ΔL of the edge strength is negative, the more the variation ΔL of the edge strength decreases (an absolute value increases), that is, the more the current position N of the cursor moves away from the outline OL of an object, the more the cursor speed setting section 43 sets the moving speed of the cursor to a lower speed.

In a word, in the case where the variation of the edge strength is positive, the more the absolute value of this edge strength increases, the more the cursor speed setting section 43 sets the moving speed of the cursor to a higher speed. On the other hand, in the case where the variation of the edge strength is negative, the more the absolute value of this edge strength increases, the more the cursor speed setting section 43 sets the moving speed of the cursor to a lower speed.

### [Cursor Speed Setting Process]

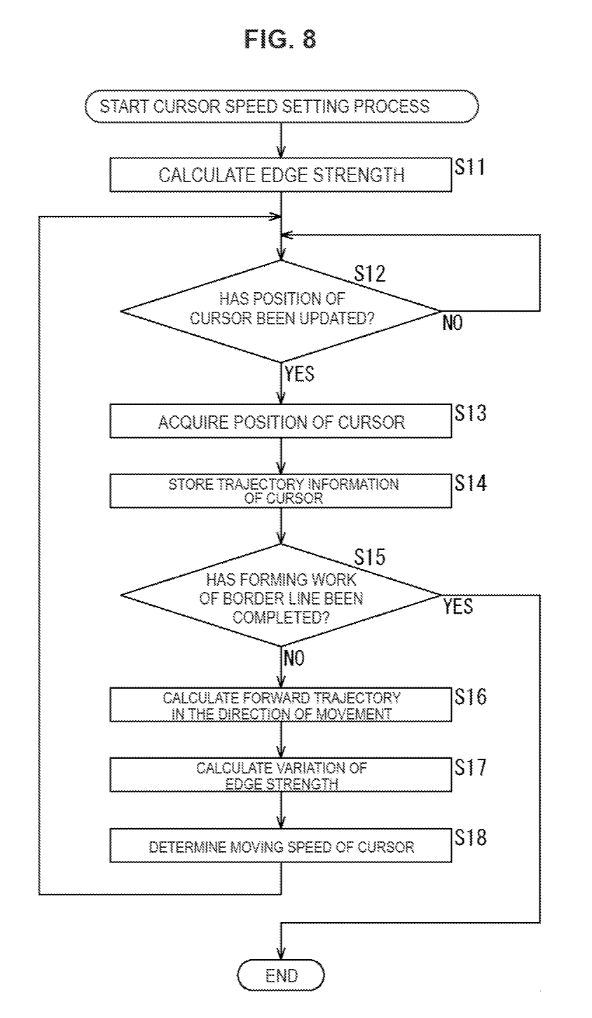

Next, a process in which the image processing apparatus 10 sets the moving speed of the cursor (hereinafter, called a cursor speed setting process) will be described by referring to FIG. 8.

FIG. 8 is a flow chart describing the flow of the cursor speed setting process.

In step S11, the edge strength calculation section 22 calculates the edge strengths for all pixels of the image data supplied from the image data input section 21 as an object to be processed.

In step S12, the cursor position acquisition section 24 judges whether or not the position of the cursor has been updated. That is, the cursor position acquisition section 24 judges whether or not an operation signal has been supplied from the operation section 23.

In the case where the position of the cursor has not been updated, it is judged as NO in step S12, the process returns to step S12, and the judgment process of step S12 is repeated until the position of the cursor has been updated.

Afterwards, in the case where the position of the cursor has been updated, it is judged as YES in step S12, and the process proceeds to step S13.

In step S13, the cursor position acquisition section 24 acquires coordinates (xn, yn) of the current position N of the cursor, based on the operation signal supplied from the operation section 23.

In step S14, the cursor trajectory setting section 25 stores by adding the coordinates (xn, yn) of the current position N of the cursor acquired by step S13 into a trajectory list as trajectory information.

In step S15, the cursor position acquisition section 24 judges whether or not forming work of a border line of the region to be image processed is completed.

In the case where forming work of the border line is not completed, it is judged to be NO in step S15, and the process progresses to step S16.

In step S16, the forward direction of movement prediction section 41 calculates a forward trajectory in the direction of movement centered on the current position N of the cursor acquired by step S13.

In step S17, the edge strength variation calculation section 42 calculates a variation ΔL of the edge strength. That is, the edge strength variation calculation section 42 calculates a variation ΔL of the edge strength from the maximum value Lfmax and the minimum value Lfmin of the edge strength L in the forward trajectory in the direction of movement of the cursor calculated by step S16, and the maximum value Lbmax and the minimum value Lbmin of the edge strength L in the previous trajectory of the cursor.

In step S18, the cursor speed setting section 43 determines the moving speed of the cursor, based on the variation ΔL of the edge strength calculated by step S17.

When the moving speed of the cursor has been determined, the process returns to step S12, and the processes from this point are repeated. That is, until forming work of the border line of the region to be image processed is judged to be completed in step S15, the processes of step S12 to step S18 are repeated.

Afterwards, in the case where forming work of the border line is completed, it is judged as YES in step S15, and the cursor speed setting process ends.

In this way, while forming work of the border line of the region to be image processed is being performed, the moving speed of the cursor is dynamically set depending on the variation of the edge strength in the current position of the cursor. Therefore, it becomes easy for a user to perform a moving operation of the cursor along the outline of an object, and the user can easily perform forming work of the border line along the outline of an object.

### [Use Example of Trajectory Information in Another Image Processing Apparatus]

The trajectory information stored in the cursor trajectory storage section 25 can be used by being supplied to another image processing apparatus 11. The use of the trajectory information in the another image processing apparatus 11 will be described by referring to FIGS. 9 to 12.

FIG. 9 is a figure showing a configuration example of the another image processing apparatus 11.

As shown in FIG. 9, the another image processing apparatus 11 has a region to be processed setting section 61.

The region to be processed setting section 61 acquires trajectory information from the cursor trajectory storage section 25 of the image processing apparatus 10. Then, the region to be processed setting section 61 sets the region to be processed for an image to be processed (an image similar to the image to be processed of the image processing apparatus 10) by using the acquired trajectory information, and performs a prescribed picture process, such as color correction, for example.

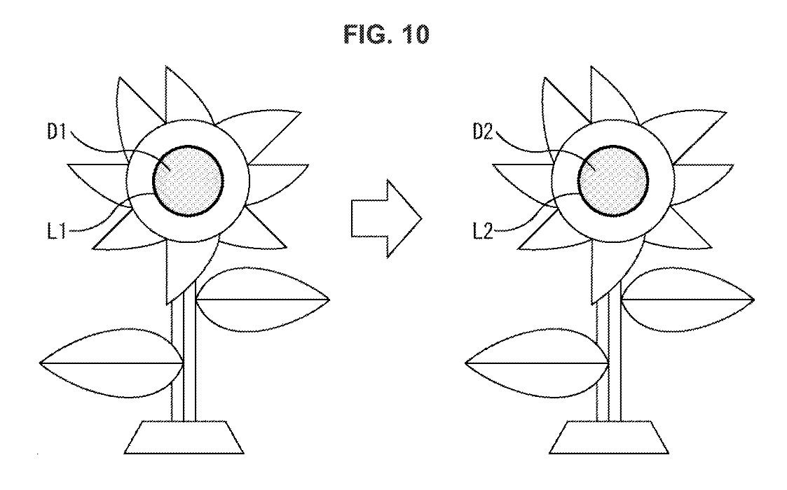

FIG. 10 is a figure describing the use of the trajectory information in the another image processing apparatus 11 having a configuration such as that of FIG. 9.

As shown in the left hand side figure of FIG. 10, the border line L1 of the region D1 to be processed is formed from within the image to be processed, by forming work of the border line of the region to be processed of the image process in the image processing apparatus 10. In this case, the coordinates on the border line L1 are stored, as trajectory information, in the cursor trajectory storage section 25 of the image processing apparatus 10.

The region to be processed setting section 61 of the another image processing apparatus 11 acquires trajectory information from the cursor trajectory storage section 25 of the image processing apparatus 10. Then, the region to be processed setting section 61 sets the border line L2 of the region D2 to be processed for an image to be processed, similar to the image to be processed in the image processing apparatus 10, by using the acquired trajectory information. Here, the region D2 to be processed is similar to the region D1 to be processed in the image processing apparatus 10, and the border line L2 is similar to the border line L1 in the image processing apparatus 10. In this way, the another image processing apparatus 11 can apply a prescribed image process, such as color correction, for example, to the region D2 to be processed set by the region to be processed setting section 61.

In this way, the another image processing apparatus can set a region to be processed by using trajectory information stored in the image processing apparatus 10 applicable to be present disclosure. In this way, it becomes possible for the another image processing apparatus 11 to efficiently perform an image process for this region to be processed that can shorten forming work of the border line of the region to be processed.

### [Another Use Example of the Trajectory Information in the Another Image Processing Apparatus]

Next, a method of use of the trajectory information, in the case where the first or second techniques described above are adopted for the another image processing apparatus 11 as techniques for simplifying forming work of the border line of the region to be image processed, will be described.

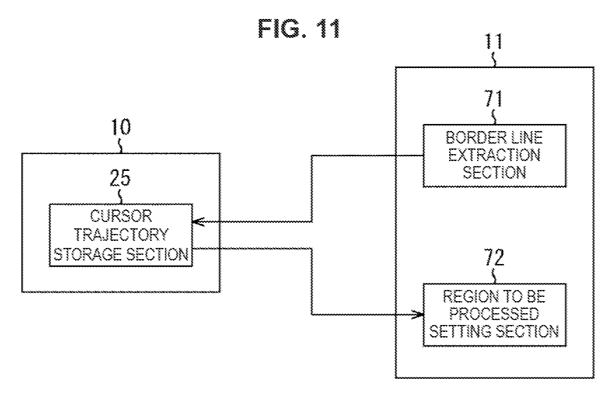

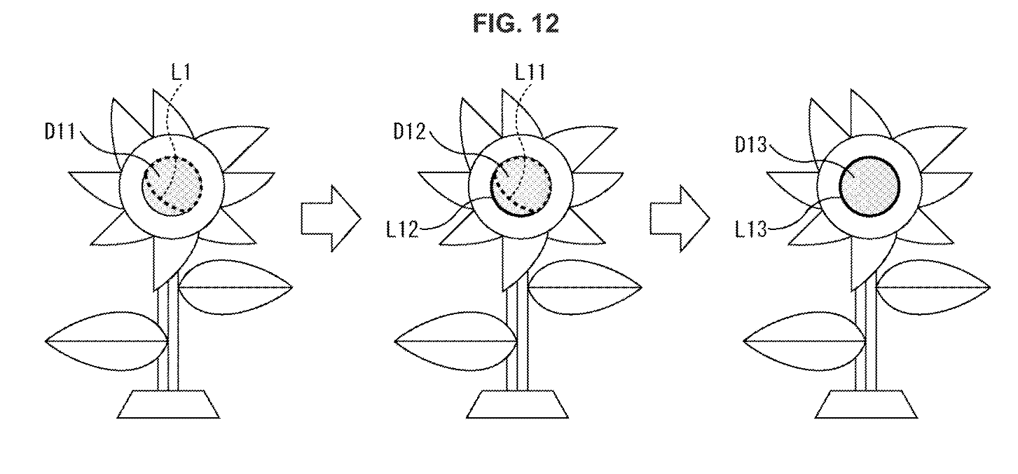

As described above, in the case where a border line is extracted by the another image processing apparatus 11 adopting the first or second techniques, the user may have to correct this border line. Accordingly, so as to dispense with a correction by the user, the another image processing apparatus 11 has the configuration shown in FIG. 11.

FIG. 11 is a figure showing a configuration example of the another image processing apparatus 11.

As shown in FIG. 11, the another image processing apparatus 11 has a border line extraction section 71 and a region to be processed setting section 72.

The border line extraction section 71, in accordance with the first or second techniques, extracts the outline of an object specified by an operation of the user as a border line of the region to be processed. In more detail, the border line extraction section 71 extracts a coordinate group of this border line. Then, the border line extraction section 71 supplies the coordinate group of this border line to the image processing apparatus 10.

When the coordinate group of this border line is acquired, the image processing apparatus 10 stores this coordinate group as trajectory information, and in the case where forming work of the border line is performed, the border line is corrected by performing the various processes described above using this trajectory information. Then, the image processing apparatus 10 stores the coordinates of the border line after it is corrected in the cursor trajectory storage section 25 as trajectory information.

The region to be processed setting section 72 acquires the trajectory information after it is corrected from the image processing apparatus 10. Then, the region to be processed setting section 72 sets the region to be processed from the image data to be processed by using the acquired trajectory information, and applies an image process, such as color correction, for example, to this region to be processed.

FIG. 12 is a figure describing the use of trajectory information in the another image processing apparatus 11 having a configuration such as that of FIG. 11.

The border line extraction section 71 of the another image processing apparatus 11, in accordance with the first or second techniques, performs forming work of a border line, and as shown in the left hand side figure of FIG. 12, forms a border line L11 of the region D11 to be processed, from within the image to be processed. The formed border line L11 is shown by a dotted line. Then, the border line extraction section 71 extracts a coordinate group of the border line L11 shown by the dotted line, and supplies the coordinate group to the image processing apparatus 10.

The image processing apparatus 10 stores the coordinate group of the supplied border line L11 as trajectory information, and in the case where forming work of the border line is performed, corrects the border line L11 to a border line L12, as shown by the central figure of FIG. 12, by performing the various processes described above using this trajectory information. Note that in this figure, the border line L11 before it is corrected is shown by a dotted line, and the border line L12 after it is corrected is shown by a solid line. The image processing apparatus 10 stores the coordinate group of the border line L12 after it is corrected in the cursor trajectory storage section 25 as trajectory information. Then, the image processing apparatus 10 receives an acquisition request or the like from the another image processing apparatus 11, and supplies the trajectory information to the another image processing apparatus 11 by reading out trajectory information from the cursor trajectory storage section 25.

When the trajectory information is acquired, as shown in the right hand side figure of FIG. 12, the region to be processed setting section 72 of the another image processing apparatus 11 sets a border line L13 of the region D13 to be processed from the image data to be processed, by using this trajectory information. Here, as can be clearly seen by comparing the left hand side and central figures of FIG. 12, the region D13 to be processed is the same as the region D12 to be processed in the image processing apparatus 10, and the border line L13 is similar to the border line L12 in the image processing apparatus 10.

In this way, since the another image processing apparatus 11 can apply an image process, such as color correction, to the region D13 to be processed similar to the corrected region D12 to be processed in the image processing apparatus 10, correction work by a manual operation of the user becomes unnecessary. That is, the another image processing apparatus 11 can set the region to be processed from the image data to be processed, by using the trajectory information of the corrected border line in the image processing apparatus 10 applicable to the present disclosure. In this way, it is possible for the another image processing apparatus 11 to efficiently perform an image process that can shorten correction work of the extracted border line, for forming work of the border line of the region to be processed.

Note that while the image processing apparatus 10 and the another image processing apparatus 11 have been described as two different image processing apparatuses in the above example, they may be one combined image processing apparatus. That is, the processes performed by the image processing apparatus 10 and the another image processing apparatus 11 may be performed within one image processing apparatus.

### [Application of Present Technology to Program]

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

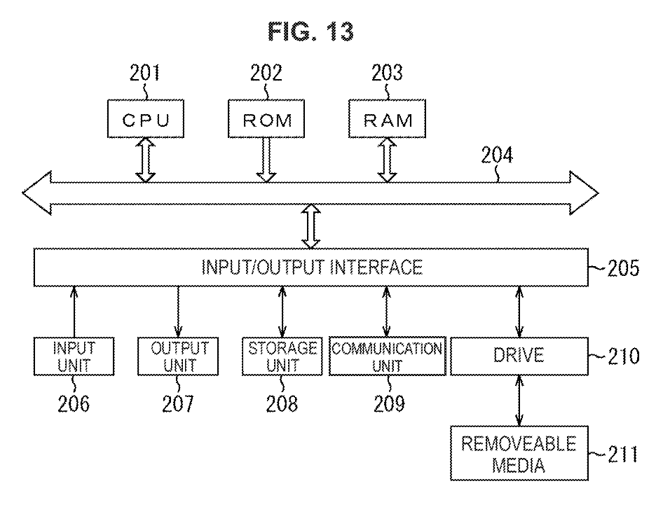

FIG. 13 is a block diagram showing an example configuration of the hardware of a computer that executes the series of processes described earlier according to a program.

In the computer, a central processing unit (CPU) 201, a read only memory (ROM) 202 and a random access memory (RAM) 203 are mutually connected by a bus 204.

An input/output interface 205 is also connected to the bus 204. An input unit 206, an output unit 207, a storage unit 208, a communication unit 209, and a drive 210 are connected to the input/output interface 205.

The input unit 206 is configured from a keyboard, a mouse, a microphone or the like. The output unit 207 is configured from a display, a speaker or the like. The storage unit 208 is configured from a hard disk, a non-volatile memory or the like. The communication unit 209 is configured from a network interface or the like. The drive 210 drives a removable media 211 such as a magnetic disk, an optical disk, a magneto-optical disk, a semiconductor memory or the like.

In the computer configured as described above, the CPU 201 loads a program that is stored, for example, in the storage unit 208 onto the RAM 203 via the input/output interface 205 and the bus 204, and executes the program. Thus, the above-described series of processing is performed.

Programs to be executed by the computer (the CPU 201) are provided being recorded in the removable media 211 which is a packaged media or the like. Also, programs may be provided via a wired or wireless transmission medium, such as a local area network, the Internet or digital satellite broadcasting.

In the computer, by inserting the removable media 211 into the drive 210, the program can be installed in the storage unit 208 via the input/output interface 205. Further, the program can be received by the communication unit 209 via a wired or wireless transmission media and installed in the storage unit 208. Moreover, the program can be installed in advance in the ROM 202 or the storage unit 208.

It should be noted that the program executed by a computer may be a program that is processed in time series according to the sequence described in this specification or a program that is processed in parallel or at necessary timing such as upon calling.

The embodiment of the present technology is not limited to the above-described embodiment. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing apparatus, including:
an edge strength calculation section which respectively calculates edge strengths for all pixels of an image represented by image data set as an object to be processed;
a cursor position acquisition section which successively acquires positions of a cursor on a display screen on which the image is displayed; and
cursor speed setting section which sets a moving speed of the cursor based on a variation of the edge strength in a current position of the cursor, calculated based on the positions of the cursor successively acquired by the cursor position acquisition section and the edge strengths calculated by the edge strength calculation section.

(2) The image processing apparatus according to (1),
wherein the cursor speed setting section sets the moving speed of the cursor so that, in a case where the variation of the edge strength is positive, the more an absolute value of the edge strength increases, the more the moving speed of the cursor is set to a higher speed, and in a case where the variation of the edge strength is negative, the more an absolute value of the edge strength increases, the more the moving speed of the cursor is set to a lower speed.

(3) The image processing apparatus according to (1) or (2),
wherein the cursor speed setting section calculates forward positions of the cursor in a direction of movement of the current position of the cursor, and calculates the variation of the edge strength in the current position of the cursor, by using the edge strength in each of the calculated forward positions of the cursor, and backward positions of the cursor in the direction of movement already obtained by the cursor position acquisition section.

(4) The image processing apparatus according to any of (1) to (3),
wherein the cursor speed setting section calculates, as the forward positions of the cursor, positions at point symmetry of the backward positions of the cursor centered on the current position of the cursor.

(5) The image processing apparatus according to any of (1) to (4),
wherein the cursor speed setting section obtains an approximate curved line represented by a multiple-order polynomial equation, from the backward positions of the cursor, and calculates the forward positions of the cursor by using the approximate curved line.

(6) The image processing apparatus according to any of (1) to (5),
wherein the cursor speed setting section calculates the variation of the edge strength in the current position of the cursor, by using a maximum value and a minimum value of the edge strengths in the backward positions of the cursor, and a maximum value and a minimum value of the edge strengths in the forward positions of the cursor.

For example, the present disclosure can be applied to an image processing apparatus which edits images.

What is claimed is:

1. An image processing apparatus, comprising:
an edge strength calculation section which respectively calculates edge strengths for all pixels of an image represented by image data set as an object to be processed;
a cursor position acquisition section which successively acquires positions of a cursor on a display screen on which the image is displayed; and
a cursor speed setting section which sets a moving speed of the cursor based on a variation of the edge strength in a current position of the cursor, calculated based on the positions of the cursor successively acquired by the cursor position acquisition section and the edge strengths calculated by the edge strength calculation section.

2. The image processing apparatus according to claim 1, wherein the cursor speed setting section sets the moving speed of the cursor so that, in a case where the variation of the edge strength is positive, the more an absolute value of the edge strength increases, the more the moving speed of the cursor is set to a higher speed, and in a case where the variation of the edge strength is negative, the more an absolute value of the edge strength increases, the more the moving speed of the cursor is set to a lower speed.

3. The image processing apparatus according to claim 2, wherein the cursor speed setting section calculates forward positions of the cursor in a direction of movement of the current position of the cursor, and calculates the variation of the edge strength in the current position of the cursor, by using the edge strength in each of the calculated forward positions of the cursor, and backward positions of the cursor in the direction of movement already obtained by the cursor position acquisition section.

4. The image processing apparatus according to claim 3, wherein the cursor speed setting section calculates, as the forward positions of the cursor, positions at point symmetry of the backward positions of the cursor centered on the current position of the cursor.

5. The image processing apparatus according to claim 3, wherein the cursor speed setting section obtains an approximate curved line represented by a multiple-order polynomial equation, from the backward positions of the cursor, and calculates the forward positions of the cursor by using the approximate curved line.

6. The image processing apparatus according to claim 3, wherein the cursor speed setting section calculates the variation of the edge strength in the current position of the cursor, by using a maximum value and a minimum value of the edge strengths in the backward positions of the cursor, and a maximum value and a minimum value of the edge strengths in the forward positions of the cursor.

7. An image processing method of an image processing apparatus, comprising:
respectively calculating edge strengths for all pixels of an image represented by image data set as an object to be processed;
successively acquiring positions of a cursor on a display screen on which the image is displayed; and
setting a moving speed of the cursor based on a variation of the edge strength in a current position of the cursor, calculated based on the successively acquired positions of the cursor and the edge strengths.

8. A program for causing a computer to function as:
an edge strength calculation section which respectively calculates edge strengths for all pixels of an image represented by image data set as an object to be processed;
a cursor position acquisition section which successively acquires positions of a cursor on a display screen on which the image is displayed; and
a cursor speed setting section which sets a moving speed of the cursor based on a variation of the edge strength in a current position of the cursor, calculated based on the positions of the cursor successively acquired by the cursor position acquisition section and the edge strengths calculated by the edge strength calculation section.
